(19) United States
(12) Patent Application Publication
(10) Pub. No.: US 2003/0176526 A1
(43) Pub. Date: Sep. 18, 2003

(54) Polymeric compositions

(76) Inventor: Peter Weissman, Woodstock, GA (US)

Correspondence Address: WENDEROTH, LIND & PONACK, L.L.P., 2033 K STREET N. W., SUITE 800, WASHINGTON, DC, 20006-1021, US

(21) Appl. No.: 10/046,775

(22) Filed: Jan. 17, 2002

(51) Int. Cl. C08G 2/00

(52) U.S. Cl. 522/113

(57) ABSTRACT

Radiation-curable formulation substantially-free of volatile organic compounds (VOCs), the formulation comprising

(a) from about 5% to about 70% by weight of an a monomer diluent comprising at least one activated unsaturated moiety;

(b) optionally up to about 10% by weight a photo-initiator; and

(c) from about 30% to about 95% by weight of at least one polymer and/or oligomer obtained and/or obtainable from a monomer comprising at least one activated unsaturated moiety,

where the formulation and/or components thereof exhibit at least one of the following properties:

(w) the polymer component (c) has a solubility parameter (heat of fusion per unit volume) of more than about 15 J^{1/2} cm^{-3/2};

(x) the polymeric component (c) has a number average molecular weight (Mₙ) of less than about 15,000 daltons;

(y) the formulation has a viscosity of up to about 10,000 centipoise and no more than 50% of diluent; and/or

(z) the polymeric component (c) having a dispersing power (⊖) of up to about 1.0 DP(equivalents)/(mol×daltons).

The present invention relates to improved formulations using certain polymer precursors which have advantageous properties for example for use as inks e.g. for flexographic applications.

### BACKGROUND OF THE INVENTION

A new class of low molecular weight and/or functional acrylic polymers have recently been discovered and are described in, for example, U.S. Ser. No. 60/215,721 (abandoned), co-pending U.S. patent application Ser. No. 09/886,192 (Rohm & Haas), and U.S. Pat. No. 4,414,370 (S C Johnston), U.S. Pat. No. 4,529,787 (S C Johnston), U.S. Pat. No. 4,546,160 (S C Johnston), U.S. Pat. No. 5,010,166 (S C Johnston), U.S. Pat. No. 5,475,073 (Arco), U.S. Pat. No. 5,525,693 (Arco), U.S. Pat. No. 5,646,213 (Arco) and U.S. Pat. No. 5,646,225 (Arco), the subject matter of which is incorporated by reference herein

The applicant has surprisingly discovered that when such oligomers are used to prepare formulations for example for radiation curing in the absence of undesirable species such as volatile organic compounds (VOCs), such formulations (e.g. radiation curable inks) exhibit advantageous properties.

### BRIEF SUMMARY OF THE INVENTION

Therefore broadly in accordance with the present invention there is provided a radiation-curable formulation substantially-free of volatile organic compounds (VOCs), the formulation comprising:

(a) from about 5% to about 70% by weight of an a monomer diluent comprising at least one activated unsaturated moiety;

(b) optionally up to about 10% by weight a photo-initiator; and

(c) from about 30% to about 95% by weight of at least one polymer and/or oligomer obtained and/or obtainable from a monomer comprising at least one activated unsaturated moiety,

where the formulation and/or components thereof exhibit at least one of the following properties:

(w) the polymer component (c) has a solubility parameter (heat of fusion per unit volume) of more than about 15 J^{1/2} cm^{-3/2};

(x) the polymeric component (c) has a number average molecular weight (Mₙ) of less than about 15,000 daltons;

(y) the formulation has a viscosity of up to about 10,000 centipoise and no more than 50% of diluent; and/or

(z) the polymeric component (c) having a dispersing power (⊖) as defined herein of up to about 1.0.

### DETAILED DESCRIPTION OF THE INVENTION

The monomer used to form polymeric component (c) may be the same as or different from the diluent monomer(s) used in component (a).

A solubility parameter (SP) is a means of quantifying the way that “like dissolves like”. SP can be derived from a cohesive energy density defined as:

$$ChesiveEnergyDensity ( CED ) = \frac{Δ E}{V} = \frac{Δ H - RT}{V} , where$$

$$\begin{matrix}Δ E = Energy required to vaporize 1 cc of solvent ; \\ V = Molar volume ( i . e . molecular weight \text{/} density ) ; \\ Δ H = Latent heat of vaporization ; \\ R = Gas constant \\ T = Temperature\end{matrix}$$

The SP can thus be based on three components (following the known approach used by van Krevelen) namely a dispersive (non-polar) component, a polar component and a hydrogen bonding component. Thus the SP can be defined as

Solubility Parameter=\sqrt{CED}=\sqrt{CED_{Dispersive}²+CED_{Polar}²+CED_{H-Bonding}²}

The SP can be used to measure resin compatibility, resin solubility and/or resin and diluent/solvent compatibility. SP can be determined indirectly by testing solubility in solvents with known solubility parameters, then plotting on SP chart (e.g., H-bonding vs. Polar). To do this the resin is dissolved in solvent, titrated to a cloud point with non-solvent, and then the solubility parameter can be calculated on solvent blend composition (e.g., KB value). One can also calculate SP from the molecular structure of a resin, for example from structural groups such as CH₃—, phenyl, C═O, —OH, CH₂═, etc.

Preferably for oligomers used to formulate preferred inks of the invention as described and exemplified herein, the oligomer exhibits a solubility parameter of from about 15 J^{1/2} cm^{-3/2} to about 30 J^{1/2} cm^{-3/2}; more preferably from about 18 J^{1/2} cm^{-3/2} to about 25 J^{1/2} cm^{-3/2}.

Preferably the number average molecular weight (Mn) of the polymer component (c) is from about 200 to about 20,000 daltons, more preferably from about 500 to about 15,000 daltons, most preferably from about 1000 to about 10,000 daltons.

Preferred formulations of the invention have a viscosity of up to about 2,000 centipoise per g of polymeric component (c) at a temperature of 25° C.

The dispersing power (denoted herein by ⊖) of a functional polymer is given as a product of two parameters ε and ρ divided by the average molecular weight of the polymer to give value of the dispersing strength of the polymer per unit weight, i.e.

⊖=ε×ρ/M_{w}.

Preferably ⊖ is from about 1×10⁻⁵ to about 0.8, more preferably from about 1×10⁻³ to about 0.5; most preferably from about 0.01 to about 0.1 DP (equivalents)/(mol×daltons).

ε is a measure of the ability of a polymer to disperse a polar substance (such as a colorant) in a suitable fluid and is the product of the average electric dipole moment μₐ and to the average polarizability αₐ of all the polar substituent groups on the polymer, thus

ε=μₐ×αₐ

ε is measured in units of DP (1 DP=3.336 10⁻³⁰ C·m×1×10⁻²⁴cm³=3.336×10⁻⁵⁸C·m⁴) and preferably is less than about 400 DP (C·m=coulomb meter).

ρ is a measure of the concentration of all polar substituents on a polymer measured in units of equivalents per mol (of polymer); and is preferably less than about 100 equivalents per mol.

M_{w} is the weight average molecular weight of the polymer (measured by GPC/MS using a polystyrene standard) and is preferably less than about 25,000 daltons.

An electric dipole consists of two electric charges ⁻q and ⁺q separated by a distance d. It is represented by a vector directed from the negative to the positive charge. The magnitude of this vector is given by “qd” and is called the electric dipole moment, which is conveniently measured herein in Debye units (D) where 1D=3.336 10⁻³⁰ C.m. A polar group is a chemical species having a permanent dipole moment (also denoted herein by “μ”) which exists independently of any applied electric field. This occurs whenever the mean center of the negative charge on the species is different from the mean center of the positive charge on that species. All values for the (scalar) electric dipole moment quoted herein are those obtained when measured in the gas phase by standard techniques well known in the art.

The electric dipole polarizability of a chemical species is equal to the electrical moment of a dipole induced in that species divided by the field intensity. Conveniently the electric dipole polarizability measured as an average over the chemical species' (e.g. molecule's) ground state is given herein in units of 1×10⁻²⁴ cm³ (which is denoted herein by the abbreviation “P”). Polarizability can be considered a measure of the ability of a species to exhibit a whole or partial electric charge and is also denoted herein by “α”.

Thus the parameter μₐ is a measure of the overall polarity of the polymer component (c) and is a scalar quantity independent of the sign of the charge and αₐ is a reflection of the readiness of the polymer component (c) to hold charge and both together give a measure of the ease of which a given amount of polymer will disperse a material containing polar groups such as a common colorants which contain polar chromophores such as azo groups and/or phthalocyanine rings.

The polymeric component (c) may comprise those polar substituents thereon which on average have exhibit an electric dipole moment (μₐ) of from about 0.01 D to about 15 D and/or an average electric polarizability (αₐ) of from about 1 to about 25 P; thus preferably ε may be from about 0.01 to about 375 DP.

Preferably μₐ is from about 0.01 D to about 10 D, more preferably from about 0.5 D to about 7 D; most preferably from about 1 D to about 5 D. Preferably αₐ is from about 2 P to about 20 P more preferably about 4 P to about 17 P; most preferably about 5 P to about 15 P.

Preferably the density of polar substituents (ρ) is from about 1 to about 100, more preferably from about 2 to about 50, most preferably from about 3 to about 20 equivalents per mol of polymer.

Preferably the molecular weight (Mw) of the polymer component (c) is from about 1,000 to about 25,000 daltons, more preferably from about 1,500 to about 20,000 daltons, most preferably from about 2000 to about 15,000 daltons.

Preferably component (a) and/or (c) comprise an oligomer, more preferably which is polymerisable by radiation, most preferably which comprises at least one activated unsaturated moiety as defined herein.

Component (a) and/or (c) may conveniently be selected from one or more of the specific polymer types I to IX as described herein.

Polymers of type I comprise types A, B and C as described and exemplified herein, preferably comprise those described in the co-pending application U.S. Ser. Nos. 60/215,721 or 09/886,192 (Rohm & Haas), the contents of which are hereby incorporated by reference; more preferably comprise semi-telechelic nitrogen-functional oligomers of formula

R₁R₂N—(CH₂)ₘ—(NH)ₙ-A

in which

A is the residue of a macromonomer bearing at least one pendant ethylenic unsaturation with a degree of polymerization from about 2 to about 50;

n is 0 or 1;

m is from 0 to 18

R₁ and R₂ are both independently selected from H, and optionally substituted C₁₋₁₈hydrocarbo;

Preferably when n is 0, m is 0 and when n is 1; m is from 0 to 18, more preferably from 1 to 18.

Preferably R₁ and R₂ are both independently selected from H, and C₁₋₁₂branched, unbranched and cyclic alkyl, phenyl and substituted phenyl where R₁ and R₂ are other than both H;

Preferably R₁R₂N— forms a cyclic group.

Polymers of type II comprise those described in U.S. Pat. No. 4,414,370 (S. C. Johnston) the contents of which are hereby incorporated by reference, more preferably comprise low molecular weight vinylic polymers of at least one monoalkenyl aromatic monomer and at least one acrylic monomer having a dispersion index less than about 2 and a number average molecular weight from about 1000 to 6000 obtained and/or obtainable by a bulk polymerisation process which comprises the steps of continuously:

(a) charging a mixture of vinylic monomers into a continuous stirred reactor zone containing a molten resin mixture of unreacted vinylic monomers and said vinylic polymer product;

(b) maintaining the molten resin mixture at a reaction temperature from about 235° C. to 310° C.; and

(c) maintaining a flow rate through said reaction zone sufficient (1) to provide a residence time of said charged vinylic monomer mixture in said reaction zone of at least about 2 minutes to provide a reaction product; and (2) to maintain a predetermined level of reaction mixture in said reaction zone.

Polymers of type III comprise those described in U.S. Pat. No. 4,529,787 (S. C. Johnston) the contents of which are hereby incorporated by reference, more preferably comprise low molecular weight vinylic polymer having a narrow molecular weight distribution and a low chromophore content, the polymer obtained and/or obtainable by a bulk polymerization process comprising the steps of continuously:

(a) charging into a continuous mixed reactor zone containing a molten resin mixture;

(i) a mixture of vinyl monomers comprising at least one monoalkenyl aromatic monomer and at least one acrylic monomer;

(ii) a polymerization initiator in amounts to provide a molar ratio of said initiator to said mixture of vinyl monomers from about 0.0005:1 to 0.04:1;

(iii) from about 0 to 25 percent based on the weight of vinyl monomers of a reaction solvent, wherein said molten resin mixture comprises unreacted vinylic monomers and the vinylic polymer product;

(b) maintaining a flow rate through said reaction zone sufficient to:

(i) provide a residence time of said charged vinylic monomer mixture in said reaction zone of from about two minutes to one hour; and

(ii) maintain a predetermined level of reaction mixture in said reaction zone, and;

(c) maintaining the molten resin mixture at a reaction temperature within the range from about 180° C. to 270° C. sufficient to provide accelerated conversion to a readily processable, uniform, concentrated polymer product having a number average molecular weight of 500 to 6000, a polydispersity of less than about 2.5 and a distribution index of less than about 4.5

Polymers of type IV comprise those described in U.S. Pat. No. 4,546,160 (S. C. Johnston) the contents of which are hereby incorporated by reference; more preferably comprise high solids, non-styrenic acrylic polymers having a number average molecular weight of about 1000 to 2500 a polydispersity ratio of less than about 3; a dispersion index of up to about 5 and a low chromophore content, the polymer obtained and/or obtainable by a continuous bulk polymerization process comprising the steps of continuously:

(a) charging into a continuous mixed reactor zone containing a molten resin mixture consisting essentially of;

(i) at least one acrylic monomer;

(ii) a polymerization initiator in amounts to provide a molar ratio of said initiator to said acrylic monomer from about 0.0005:1 to 0.06:1,

(iii) from about 0 to 25 percent based on the weight of acrylic monomers of a reaction solvent, wherein said molten resin mixture comprises unreacted acrylic monomers and the acrylic polymer product;

(b) maintaining a flow rate through said reaction zone sufficient to:

(i) provide a residence time of said charged acrylic monomer in said reaction zone of from about 1-30 minutes; and

(ii) maintain a predetermined level of reaction mixture in said reaction zone, and;

(c) maintaining the molten resin mixture at an elevated temperature with the range of from about 180° C. to 270° C. sufficient to provide accelerated conversion to a readily processable, uniform, concentrated polymer product.

Polymers of type V comprise those described in U.S. Pat. No. 5,010,166 (S. C. Johnston) the contents of which are hereby incorporated by reference; more preferably comprise graft polymers having at least one main chain and a plurality of side chains attached thereto obtained and/or obtainable by a continuous polymerization process comprising the steps of:

combining in a reaction zone an (1) addition-polymerizable monomer that is also a free-radical initiator together with an (2) ethylenically-unsaturated monomer having a nucleophilic or an electrophilic moiety at a reaction temperature that is effective for initiating addition co-polymerization of the addition-polymerizable monomer with the ethylenically-unsaturated monomer, wherein propagation by the addition co-polymerization reaction forms the main chain of the graft polymer; while also combining in the reaction zone a polymerizable, carbonyl carbon-containing ringed molecule at a super atmospheric pressure effective, at the elevated temperature, to cause the ring portion of the ringed molecule to open in the vicinity of the carbonyl carbon thereof in response to the presence of the nucleophilic or the electrophilic moiety of the ethylenically-unsaturated monomer, for initiating ionic co-polymerization of the polymerizable ringed molecule with the nucleophilic-containing or electrophilic-containing moiety of the ethylenically-unsaturated monomer, wherein propagation by the ionic co-polymerization reaction forms the side chains of the graft polymer; and

terminating both of the addition co-polymerization and the ionic co-polymerization reactions when the thus-produced graft polymer attains a predetermined number-average and/or weight-average molecule weight, the polymerization process being characterized in that each of the main-chain and side-chain propagations occurs substantially simultaneously, relative to the other, and wherein the polymerization process is further characterized in that the ionic co-polymerization reaction occurs expressly excluding utilization of a catalyst for the carbonyl carbon-containing ringed molecule.

Polymers of type V comprise low molecular weight hydroxy-functional acrylate resins optionally water reducible and/or water dispersible, the resin comprising recurring units of:

(a) an allylic alcohol (optionally in amount of about 5 to about 50% by weight), the alcohol having the general structure:

CH₂═CR—CH₂(A)ₙOH

in which

n is less than about 3.0;

A is a (C₁₋₁₂hydrocarbylene)oxy group; and

R is selected from the group consisting of: hydrogen and C₁₋₁₂hydrocarbyl;

(b) a C₁₋₂₀hydrocarbyl; vinyl aromatic; aryl acrylate and/or methacrylate monomer; (optionally in amount of about 50% to about 90% by weight);

(c) optionally, one or more ethylenically unsaturated monomers (optionally in an amount from about 1 to about 50% by weight), the monomers selected from the group consisting of vinyl aromatic monomers, unsaturated nitriles, vinyl esters, vinyl ethers, vinyl halides, vinylidene halides, unsaturated anhydrides, unsaturated dicarboxylic acids, (meth)acrylic acids; (meth)acrylates, (meth)acrylamides and conjugated dienes;

where the acrylate resin has:

a hydroxyl number from about 15 to about 500 mg KOH/g;

an acid number within the range of about 5 to about 330 mg KOH/g;

a number average molecular weight Mn from about 500 to about 10,000 daltons; and/or

a T_{g} from about −20° C. to about 50° C. as measured by differential scanning calorimetry (DSC).

Polymers of type VI comprise those described in U.S. Pat. No. 5,475,073 (Arco) the contents of which are hereby incorporated by reference; more preferably comprise low-molecular-weight, hydroxy-functional acrylate resins which comprise recurring units of:

(a) a propoxylated allylic alcohol of the formula

CH₂═CR—CH₂(A)ₙOH

in which

A is an oxypropylene group,

R is selected from the group consisting of hydrogen and C₁₋₅alkyl, and

n, which is the average number of oxypropylene groups in the propoxylated allylic alcohol, has a value less than or equal to 2;

(b) C₁₋₂₀alkyl or aryl acrylate or methacrylate monomer, and

(c) optionally, one or more ethylenic monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, acrylic and methacrylic acids, acrylamide and methacrylamide, and conjugated dienes;

where the acrylate resin has a hydroxyl number within the range of about 50 to about 450 mg KOH/g, and a number average molecular weight within the range of about 500 to about 10,000.

Polymers of type VII comprise those described in U.S. Pat. No. 5,525,693 (Arco) the contents of which are hereby incorporated by reference; more preferably comprise low molecular weight, hydroxy functional acrylate resins which comprise recurring units of:

(a) an allylic alcohol having the general structure

CH₂═CR—CH₂OH

in which R is selected from the group consisting of hydrogen and C₁₋₅alkyl, and

(b) a C₁₋₂₀alkyl or aryl acrylate or methacrylate monomer; and

(c) optionally, one or more ethylenic monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, acrylic and methacrylic acids, acrylamide and methacrylamide, and conjugated dienes;

wherein the acrylate resin has a hydroxyl number within the range of about 20 to about 500 mg KOH/g, and a number average molecular weight within the range of about 500 to about 10,000.

Polymers of type VII comprise those described in U.S. Pat. No. 5,646,213 (Arco) the contents of which are hereby incorporated by reference; more preferably comprise acrylic resins which comprise recurring units of:

(1) an allylic alcohol or a propoxylated allyl alcohol of the formula

CH₂═CR—CH₂(A)ₙOH

in which

A is an oxypropylene group,

R is selected from the group consisting of hydrogen and C₁₋₅alkyl, and

n, which is the average number of oxypropylene groups in the propoxylated allylic alcohol has a value within the range of about 1 to about 2;

(2) a vinyl aromatic monomer; and

(3) one or more C_{1 20}alkyl or aryl acrylate or methacrylate monomers;

where the resin has a glass-transition temperature within the range of about −20° C. to about 50° C., a hydroxyl number within the range of about 60 to about 160 mg KOH/g, and a number average molecular weight within the range of about 1000 to about 5000

Polymers of type IX comprise those described in U.S. Pat. No. 5,646,225—(Arco) the contents of which are hereby incorporated by reference; more preferably comprise water reducible and/or water dispersible resins which comprise recurring units of:

(1) from about 5 to about 50% by weight of an allylic alcohol or a propoxylated allyl alcohol of the formula

CH₂═CR—CH₂(A)ₙOH

in which

A is an oxypropylene group,

R is selected from the group consisting of hydrogen and C₁₋₅alkyl, and

n, which is the average number of oxypropylene groups in the propoxylated allylic alcohol has a value within the range of about 1 to about 2;

(2) from about 50 to about 90% by weight of a vinyl aromatic monomer; and

(3) from about 1 to about 50% by weight of an acrylic acid monomer;

where the resin has a number average molecular weight within the range of about 500 to about 10,000, a hydroxyl number within the range of about 15 to about 250 mg KOH/g, and an acid number within the range of about 5 to about 330 mg KOH/g.

Throughout this specification, the term “activated unsaturated moiety” “is used to denote species comprising at least one unsaturated carbon to carbon double bond in chemical proximity to at least one activating moiety. Preferably the activating moiety comprises any group which activates an ethylenically unsaturated double bond for addition thereon by a suitable electrophillic group. Conveniently the activating moiety comprises oxy, thio, (optionally organo substituted)amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)-carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by Formula 1′.

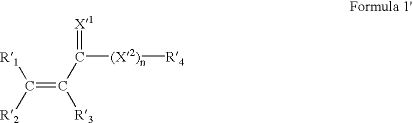

where

n′ is 0 or 1,

X′¹ is oxy or, thio

X′² is oxy, thio or NR′₅ (where R′₅ represents H or optionally substituted organo),

R′₁, R′₂, R′₃ and R′₄ each independently represent H, optionally substituents and/or optionally substituted organo groups; and

all suitable isomers thereof, combinations thereof on the same species and/or mixtures thereof.

In will be appreciated that the terms “activated unsaturated moiety”; “unsaturated ester moiety” and/or Formula 1′ herein may represent a discrete chemical species (such as a compound, ion, free radical, oligomer and/or polymer) and/or any part(s) thereof. Thus Formula 1′ may also represent multivalent (preferably divalent) radicals. Thus the options given herein for n′, X′¹, X′², R′₁, R′₂, R′₃, R′₄ and R′₅ also encompass corresponding bi or multivalent radicals as appropriate.

More preferred moieties of Formula 1′ (including isomers and mixtures thereof) are those where n′is 1; X′¹ is O; X′² is O, S or NR′₅;

R′₁, R′₂, R′₃, and R′₄ are independently selected from: H, optional substituents and optionally substituted C₁₋₁₀ hydrocarbo, and

where present R′₅ is selected from H and optionally substituted C₁₋₁₀hydrocarbo.

Most preferably n′ is 1, X′¹ is O or S and R′₁, R′₂, R′₃ and R′₄ are independently H, hydroxy and/or optionally substituted C₁₋₆ hydrocarbyl.

For example n′ is 1, X′¹ and X′² are both O; and R′₁, R′₂, R′₃ and R′₄ are independently H, OH, and/or C₁₋₄alkyl.

For moieties of Formula 1′ where n′ is 1 and X′¹ and X′² are both O then: when one of (R′₁ and R′₂) is H and also R′₃ is H, Formula 1′ represents an acrylate moiety, which includes acrylates (when both R′₁ and R′₂ are H) and derivatives thereof (when either R′₁ or R′₂ is not H). Similarly when one of (R′₁ and R′₂) is H and also R′₃ is CH₃, Formula 1′ represents an methacrylate moiety, which includes methacrylates (when both R′₁ and R′₂ are H) and derivatives thereof (when either R′₁ or R′₂ is not H). Acrylate and/or methacrylate moieties of Formula 1′ are particularly preferred.

Conveniently moieties of Formula 1′ are those where n′ is 1; X′¹ and X′² are both O; R′₁ and R′₂ are independently H, methyl or OH, and R′₃ is H or CH₃.

More conveniently, moieties of Formula 1′ are those where n′ is 1; X′¹ and X′² are both O; R′₁ is OH, R′₂ is CH₃, and R′₃ is H, and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula 1′ could be used in the context of this invention such as other reactive moieties.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers, e.g. E and/or Z forms, diastereo-isomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations (such as homo or copolymers, random, graft and/or block polymers, linear and/or branched polymers, e.g. star and/or side branched, cross-linked and/or networked polymers, polymers obtainable from di and/or tri-valent repeat units, dendrimers, polymers of different tacticity (e.g. isotactic, syndiotactic or atactic polymers); polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

As used herein the term “volatile organic compounds” (also denoted by the abbreviation VOC) are organic compounds that readily and fully evaporate and remain in the air as gases when exposed to the atmosphere at standard temperature and pressure. VOC also comprise that range of organic compounds known as semi-volatile organic compounds that will slowly and partially evaporate when exposed to the atmosphere at standard temperature and pressure. These components tend to occur both attached to solid surfaces and as liquid droplets as well as vapor in the atmosphere. Examples of VOCs include low molecular weight species for example lower alkanes such as butane; lower alkenes such as ethylene; lower aromatics such as toulene; terpenes such as 1,8 cineole (e.g. from eucalyptus oil); and/or lower alkynes such as ethyne.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises one or more of use as an radiation (e.g. UV and/or EB) curable ink and/or coating composition for example in lithography and/or flexography.

Other aspects of the present invention are disclosed in the claims.

The invention will now be illustrated by the following non-limiting examples. In the Examples the following abbreviations were used.

| | | | |
|---|---|---|---|
| AA | acrylic acid; | APA | aminopropyl amine |
| APP | 1-(3-aminopropyl)- | | |
| | 2-pyrrolidone; | | |
| BA | butyl acrylate | BDDA | 1,4-butanediol diacrylate |
| DA | n-decyl acrylate | DMAPA | N,N-dimethylaminopropyl |
| | | | amine |
| GMA | glycidyl acrylate | HBA | 4-hydroxybutyl acrylate |
| HEA | 2-hydroxyethyl | HQ | hydroquinone |
| | acrylate | | |
| LA | lauryl acrylate | MSA | methanesulfonic acid |
| OA | n-octyl acrylate | ODA | a 45/55 (% w/w) resp. |
| | | | mixture of octyl acrylate & |
| | | | decyl acrylate. |

Firstly the preparation of various known macro-monomers and oligomers are described, herein (types A to D) which include those described in U.S. application Ser. Nos. 60/215,721 and 09/886,182, the latter co-pending, the contents of which are incorporated by reference. These macro-monomers and oligomers may be used to prepare formulations of the invention described later.

The composition and molecular weight of the oligomers can be determined by many conventional analytical techniques. In the examples below, the oligomers were characterized by NMR. The mole ratio of the monomers in each oligomer was determined by proton NMR. The number average molecular weight (Mn) and the weight average molecular weight (Mw) were determined by gel permeation chromatography (GPC) using appropriate molecular weight standards. The average oligomer formula was calculated from the Mn and the mole ratio of monomers in the oligomer. The polydispersity of the oligomer was calculated from the ratio of Mw to Mn. The degree of polymerization of an oligomer is the number of monomer units incorporated into the oligomer backbone and is calculated from the mole ratio of monomers in the oligomer and the Mn.

A. Preparation of Macromonomers (Oligomers A.1 to A.7

Macromonomers of type A were prepared as described below. These monomers may be used as precursors to prepare other macromonomers as described herein (e.g. type D acrylated oligomers and/or type B nitrogen functional oligomers) and/or may be used directly to prepare formulations of the present invention.

The macromonomers were prepared by a continuous high temperature polymerization process. The polymerization reactor was a 3.05 meter (10 feet) long section of stainless steel tubing having a inner diameter of 1.6 mm (1/16^{th} inch) and a wall thickness of 1.3 mm (0.050 inch) connected at one end to a high pressure pump (Hewlett Packard Model HP 1050 TI) and at another end to a back-pressure control device. Between the two ends, the section of tubing was coiled about a torus-shaped metal mandrel. The mandrel was situated above a primary coil of a transformer so that the coils of tubing and the mandrel functioned as secondary coils of the transformer. The coils of tubing were further equipped with one end of a temperature probe. The other end of the temperature probe was connected to a temperature controlling device. The temperature controlling device regulated the current supplied to the primary coil of the transformer which regulated the heat of inductance imparted to the coiled steel tubing.

A reaction mixture was prepared by mixing monomers (at a concentration of 50%) in, solvent (acetone) and initiator (2% of tert-butyl peroxide by weight of monomers) at a pressure of 3,500 psi and under the conditions described in Table 1 below. Nitrogen was bubbled through the mixture while stirring. Solvent was pumped through the tubing via the high pressure pump at a rate of from 0.05 to 10 milliliters per minute (ml/min). The pressure was maintained at a level of from 20 MPa (200 bars) to 35 MPa (350 bars). Current was supplied to the primary coil of the transformer to raise the mandrel temperature to 230°. After about 15 minutes, the solvent being pumped through the tubing was replaced by the reaction mixture which was continuously pumped through the tubing at the same rate, temperature and pressure. After allowing the solvent to be cleared from the tubing, product was collected as the effluent from the back-pressure control device. When the addition of the reaction mixture was nearly complete, solvent was pumped through the tubing at the same rate, pressure and temperature as the reaction mixture. Solvent and residual monomer was removed on a rotary evaporator or a wiped-film evaporator.

TABLE 1
Synthesis conditions

| Example | Monomer wt ratio | Reaction temperature/° C. |
|---|---|---|
| A.1 | 99 0A/121 DA/80 HBA | 230° C. |
| A.2 | 68 BA/32 HEA | 220° C. |
| A.3 | 63 BA/37 HBA | 210° C. |
| A.4 | 67 BA/33 GMA | 200° C. |
| A.5 | 77 LA/23 GMA | 210° C. |
| A.6 | 32 OA/45 DA/23 HEA | 235° C. |
| A.7 | 52 BA/48 HEA | 350° C. |

TABLE 2
Product characteristics

| Example | Mole ratio | Mₙ | M_{w} |
|---|---|---|---|
| A.1* | 3.8 OA/4.6 DA/4.2 HBA | 2200 | 5600 |
| A.2 | 1.86 BA/1.00 HEA | 1642 | 5669 |
| A.3 | 2.45 BA/1.00 HBA | 1893 | 6912 |
| A.4 | 2.07 BA/1.00 GMA | 209 | 6890 |
| A.5 | 1.92 LA/1.00 GMA | 2216 | 5806 |
| A.6 | 0.93 OA/1.12 DA/1.00 HEA | — | — |
| A.7 | 1.33 BA/1.00 HEA | 805 | 2188 |

*A.1 was a macromonomer which was a liquid at room temperature with a polydispersity of 2.6 as measured by GPC and where approximately 70% of the macromonomer contained a terminal unsaturated group.

* A.1 was a macromonomer which was a liquid at room temperature with a polydispersity of 2.6 as measured by GPC and where approximately 70% of the macromonomer contained a terminal unsaturated group.

B. Preparation of Nitrogen-Functional Macromonomers (Oligomers B.1 & B.2)

Nitrogen-functional macromonomers of type B are prepared as described below. These monomers may be used as precursors to prepare type C semi-telechelic functional oligomers as described herein and/or may be used directly to prepare formulations of the present invention.

Oligomer B.1:

A mixture containing 500 g of Oligomer A.1 and 24.9 g of APP, was first heated for 3 hours at 80° C., then heated for 10 hours at 90° C. The relative conversion was followed using proton NMR integration of the C═C—H protons with respect to the —OCH₂₋ protons of the precursor macromonomer. After heating for another 48 hours at 120° C., the integration ratio indicated that 56% of Oligomer A.1 was converted to the nitrogen-functional Oligomer B.1. Next, another 6.2 g of APP was added to the mixture. The mixture was further heated for 24 hours at 120° C. The yield of the nitrogen-functional Oligomer B.1 was approximately 60%. The mixture was passed through a wiped film evaporator to remove un-reacted amine and other impurities to yield a brown liquid.

Oligomer B.2:

A mixture containing 350 g of Oligomer A.1 and 12.5 g of DMAPA was first heated for 3 hours at 80° C., then heated for 18 hours at 90° C., followed by further heating for 24 hours at 120° C. At this point, the conversion, as measured above for Oligomer B.1, was negligible. To the mixture, 50 g of isopropanol was added and the mixture was then heated for 72 hours at 120° C. After this reaction period, 73% of Oligomer A.1 was converted to the Oligomer B.2. A second portion of 3.1 g of DMAPA was added to the mixture and the mixture was heated for 24 hours at 120° C. The yield of the nitrogen-functional Oligomer B.2 was approximately 80%. The mixture was passed through a wiped film evaporator to remove unreacted amine and other impurities to yield a light brown liquid.

C. Preparation of Semi-Telechelic Nitrogen Functional Oligomer (Oligomers C.1 & C.2)

Semi-telechelic functional oligomers may be prepared as described herein and may be used directly to prepare formulations of the present invention.

A reaction mixture of a Monomer B, M, HQ, and toluene was added to a 1-liter, 4 neck round bottom flask equipped with a Dean-Stark trap and condenser, a thermometer, an air sparge, and overhead blade stirrer, and a serum stopper. The reaction mixture was heated to reflux at 110° C. to 120° C. for 30 minutes to removed residual moisture. Next, the catalyst, MSA, was added to the reaction mixture and the reaction mixture was heated at reflux for a period of 5 to 8 hours. The progress of the reaction was monitored by measuring the water removed from the reaction mixture. After no further water was removed, the reaction was stopped by cooling the reaction mixture containing the Oligomer C to room temperature.

TABLE 3
Reaction Mixtures and Catalyst

| Product | Oligomer C.1 | Oligomer C.2 |
|---|---|---|
| Monomer B | 348 g of B..1 | 288 g of B.2 |
| AA | 91 g | 76 g |
| Toluene | 246 g | 288 g |
| HQ | 0.7 g | 0.6 g |
| MSA | 5.1 g | 14.4 g |

Oligomer C was purified by first mixing the reaction mixture with pre-dried Amberlite IRN-78 ion exchange resin (Amberlite is a trademark of Rohm and Haas Co.) for 1 hour to remove the MSA. The ion exchange resin was removed by filtration and rinsed with toluene and then Oligomer C was passed through a wiped film evaporator at 100° C. to 120° C. and 13.3 kPa (100 mm of Hg) to remove the toluene solvent. Residual AA was removed with a second pass through the wiped film evaporator at 130° C. and 0.27 kPa (2 mm of Hg). A titration of Oligomer C showed the nitrogen-functionality had partially complexed with acid. The Oligomer C was dissolved in toluene and treated with Amberlite IRN-78 ion exchange resin to removed the acid complex. After treatment, approximately 500 ppm of HQ was added and the toluene was distilled from Oligomer C. The average composition of each of the Oligomers C.1 and C.2 was calculated using NMR to determine the ratios of the residuals of the first monomer, second monomers, the nitrogen functionality, and GPC to determine the molecular weight. Based on Mn, the weight average molecular weight, the average composition was calculated and is reported in Table 4. The BDDA residue represents the HBA residue which has been esterified with pendant AA. The nitrogen functionality is reported as the starting amine.

TABLE 4
Average Composition of Oligomers C

| | Oligomer C.1 | Oligomer C.2 |
|---|---|---|
| Av. Compn/ | 3.1 OA/3.8 DA/ | 2.6 OA/3.1 DA/ |
| (wt ratios) | 2.2 BDDA/0.22 APA | 2.0 BDDA/0.37 DMAPA |
| M_{w}/daltons | 7646 | 13,702 |
| Mₙ/daltons | 1820 | 1553 |
| HQ | 468 ppm | 508 ppm |

D. Preparation of Oligomers Containing Pendant Acrylate Groups (D.1 to D.4)

Oligomers with pendant acrylate groups may be prepared as described below (with reference to Table 5A & 5B) and may be used directly to prepare formulations of the present invention.

Reaction

A reaction flask (i) fitted with an overhead blade stirrer, a thermocouple and temperature controller connecting to a pneumatic jack with heating mantle for heating, a Dean-Stark trap and condenser and an air sparge line was charged with (ii) g of an Oligomer A, (iii) g of M, (iv) g of toulene and (v) g of HQ. The Dean-Stark trap was filled with toulene and the reaction was heated to reflux (116° C.) whilst maintaining a slow stream of air through the batch. After refluxing for about (vi) minutes and removing residual water in the Dean-Stark trap (vii) ml of MSA was added with a syringe. The air sparge and reflux was continued as water was removed and monitored in the Dean-Stark trap. After (viii) hours, (ix) % of the theoretical water was collected and the reaction mixture was cooled. The batch was treated with (x) g of Amberlite IRN-78 for 30 minutes to remove the residual MSA and then filtered. The product was isolated using a wiped film evaporator with the final pass at (xi) ° C. and about 2 mm/Hg pressure and analysed as described below.

TABLE 5A
Reaction conditions

| Example | (i) - flask | (ii) Olg. A | (iii) - AA | (iv) - Tol. | (v) - HQ |
|---|---|---|---|---|---|
| 1a = D1 | 3l, 4-neck | 651 g, A2 | 504 g | 690 g | 1.86 g |
| 1c = D2 | 2l, 4-neck | 477 g, A3 | 288 g | 394 g | 1.16 g |
| 1v = D3 | 3l, 4-neck | 812 g, A6 | 432 g | 768 g | 2.0 g |

TABLE 5B
Reaction conditions (continued)

| (vi) - reflux | | | | | |
|---|---|---|---|---|---|
| time before | (vii) - | (viii) - reflux | (ix) - % | (x) - | (xi) - evp. |
| MSA | MSA | time with MSA | water | IRN 78 | temp. |
| 15 mins | 2.2 ml | 6 hrs | 103% | 30 g | 100° C. |
| | (3.3 g) | | | | |
| 15 mins | 1.3 ml | 5 hrs | 124% | 20 g | 100° C. |
| | (1.9 g) | | | | |
| 30 mins | 1.9 ml | 3.5 hrs | 110% | 52 g | 130° C. |
| | (2.9 g)¹ | | | | |

1 At about 30% completion an additional 1.9 ml (2.9 g) of MSA was added.

Products

Oligomer D1 (Acrylate Functional BA/HEA/AA Oligomer Prepared from Oligomer A2)

The product prepared and isolated as described above was analysed and found to comprise 0.8% residual AA and 2.1% AA dimer. The batch was dissolved in about an equal volume of toulene and treated with 327 g of Amberlite IRN-78 (washed with methanol and then toulene) for one hour and then filtered. HQ (0.28 g) was added and the sample was concentrated on a Rotovap (60° C. with an air sparge) and finally isolated using a wiped film evaporator to give 474 g of the product. The product composition was determined to be (mole ratio by mnr) 2.15 BA/0.09 HEA/0.91 HEA-AA ester) and its molecular weight was determined by GPC to be 2,148 (Mₙ) and 9,300 (M_{w}).

Oligomer D2 (Acrylate Functional BAN HBA/AA Oligomer Prepared from Oligomer A3)

The product prepared and isolated as described above was analysed and found to comprise 0.04 mmol/g of titratable acid. The batch was dissolved in about an equal volume of toulene and treated with 182 g of Amberlite IRN-78 (washed with methanol and then toulene) for one hour and then filtered. HQ (0.23 g) was added and the sample was concentrated on a Rotovap (60° C. with an air sparge) and finally isolated using a wiped film evaporator to give 403 g of the product. The product composition was determined to be (mole ratio by mnr) 2.53 BA/1.00 (HBA-AA ester) and its molecular weight was determined by GPC to be 2,136 (Mₙ) and 9,698 (M_{w}).

Oligomer D3 (Acrylate Functional OA/DA/HEA/AA Oligomer Prepared from Oligomer A6)

The product prepared and isolated as described above and then HQ (0.375 g) was added to 723 g of the product (519 ppm). The product composition was determined to be (mole ratio by mnr) 0.87 OA/1.05 DA/0.12 HEA/0.88 HEA-AA ester) and its molecular weight was determined by GPC to be 2,304 (Mₙ) and 7,919 (M_{w}).

The following formulations with type C Oligomers are known from co-pending application U.S. Ser. No. 60/215,721 and are hereby disclaimed.

Oligomer C in Known Pigment Dispersions

It is known (from U.S. Ser. No. 60/215,721) to prepare pigment dispersions using certain Oligomer C type oligomers using pigment slurries and dispersions of oligomer C as follows.

A pigment slurry by adding 5 g pigment (Black-Raven 450; Irgalite® Blue GLO; Magenta-Irgalite® Rubine L4BD; or Irgalite® Yellow BAW.) and 95 g xylene to a shot mill and agitating the mixture for 20 minutes on a paint shaker. The pigment slurries were filtered through coarse paint filters and stored in sealed bottles. A dispersion was prepared by dissolving 10 g of the Oligomer C in 90 g xylene.

To a small vial, 100 μl pigment slurry (shaken to re-suspend any settled pigment), 100 μl dispersant solution and 500 μl xylene were added. The vial was capped and sonicated for 10 minutes in an ultrasonic bath to form samples of dispersed pigment which were evaluated as follows. One drop of the dispersed pigment was placed onto a microscope slide, covered with a cover slip, and allowed to sit for 2 minutes. The sample on the microscope slide was observed with a microscope at a magnification of 250×. Flocculation was readily seen as large irregularly shaped agglomerates of particles. Well dispersed samples had a uniform distribution of particles without agglomerates. Samples were rated on a scale of 1 to 5 in which 1 represents a highly agglomerated sample while 5 represents a well dispersed sample.

TABLE 6
Evaluations of Dispersed Pigments

| Dispersant | Cyan | Magenta | Yellow | Black |
|---|---|---|---|---|
| Oligomer C.1 | 1 | 5 | 2 | 5 |
| Oligomer C.2 | 1 | 5 | 5 | 5 |
| Ebecryl 450 | 3 | 4 | 3 | 1 |

Ebecryl 450 (UCB Chemicals) was used as a comparison as a well known pigment dispersant. The results in Table 6 show that it is known that Oligomers C.1 and C.2 are good pigment dispersants for magenta and black pigments and Oligomer C.2 is also a good pigment dispersant for yellow pigments.

Oligomer C.2 in a Conventional Radiation Curable Formulation

It is also known (from U.S. Ser. No. 60/215,721) that Oligomer C2 can be added to a conventional radiation curable formulation as follows.

A pigmented radiation curable formulation was prepared by mixing 10.0 g of Oligomer C.2, 3.9 g Irgalite Rubine L4BD pigment, 10.0 g trimethylolpropane triacrylate (TMPTA) and 1.0 g Irgacure 1173 photoinitiator (Irgacure is a trademark of Ciba Specialty Chemicals). A coated sample was prepared by applying a 25 μm thick film of the formulation onto a glass slide using a doctor blade. The coated sample was exposed to a dose of 1296 mJ/cm² in a Fusion Systems UV processor (Fusion UV Systems Inc.) equipped with a H bulb. The coated sample containing Oligomer C.2 cured to a solid tack-free film, indicating that oligomer was polymerized.

However such a generic formulation does not have the particularly advantageous properties as claimed for the formulations of the present invention, for example the known formulation is not substantially free of VOC.

Non limiting examples of the formulations of the inventions will now be described which use one or more oligomers prepared as described herein. The following ingredients are used herein:

A photoinitiator available commercially from Ciba additives under the trademark “Irgacure® 1173”.

A photoinitiator available commercially from Ciba additives under the trademark “Irgacure® 819”.

2-Benzyl-2-(dimethylamino)-1-[4-(4-morpholinyl)phenyl]-1-butanone (CAS no. 119313-12-1) which is a photo-initiator available commercially from Ciba additives as a yellow solid under the trademark “Irgacure® 369”.

Ethyl 4-dimethylaminobenzoate (CAS no. 10287-53-3) which is a photo-initiator available commercially from Great Lakes Fine Chemicals as a white solid under the trademark “Quanticure® EPD”.

2-Isopropylthioxanthone (CAS no. 5495-84-1) which is a photo-initiator available commercially from Great Lakes Fine Chemicals as a yellow solid under the trade name “Quanticure ITX”.

TMPEOTA which denotes trimethylolpropane ethoxy triacrylate (CAS no. 28961-43-5) available commercially from UCB Chemicals.

DPGDA which denotes dipropylene glycol diacrylate (CAS no. 57472-68-1) available commercially from UCB Chemicals.

MEHQ which denotes methyl hydroquinone (CAS no. 150-76-5), an inhibitor available commercially from Aldrich Chemicals.

The oligomer which is available commercially from UCB Chemicals under the trademark Ebecryl® 450.

The oligomer which is available commercially from UCB Chemicals under the trademark Ebecryl® 140.

Polyester acrylate oligomer grinding vehicle for flexographic ink which is available commercially from UCB Chemicals under the trade mark Ebecryl® 812.

Carbon black pigment available commercially from Columbian Chemicals under the tradename Raven 450.

Copper phthalocyanine colorant available commercially from Ciba Speciality Chemicals, pigments division, under the trademark Irgalite® Blue GLO.

Magenta colorant available commercially from Ciba Speciality Chemicals, pigments division, under the trademark Irgalite® Rubine L4BD.

Yellow colorant available commercially from Ciba Speciality Chemicals, pigments division under the trademark Irgalite® Yellow BAW.

Ink Preparation

The flexographic inks were prepared in two steps. The first step was preparation of the concentrated pigment paste (grind stage) using the Oligomer (70% by weight), and dry pigment (30% by weight). The pigments used were: Magenta-Irgalite® Rubine L4BD, Blue-Irgalite® Blue GLO, Yellow-Irgalite® Yellow BAW; or Black-Raven 450. The Anthony 5×12 three-roll mill was used 5to grind the pigment and oligomer. After no scratches were observed on the Hegman grind gage, the pigment concentrate was blended 50/50 with a standard letdown vehicle (of acrylated monomers, photoinitiator, and inhibitor—see Table 7) and dispersed for fifteen minutes to produce a final ink.

TABLE 7
Ink formulation

| Ingredient | % |
|---|---|
| Concentrate | 50.0 |
| TMPEOTA | 29.95 |
| DPGDA | 12.0 |
| Irgacure ® 369 | 2.0 |
| Quantacure ® EPD | 2.0 |
| ITX | 2.0 |
| MEHQ | 0.05 |
| Total | 100.0 |

TABLE 8
Summary of oligomers used in Inks 1 to 9 of the invention

| | | Hydrophobic | Hydroxy | Target | Degree of | Amide | Acrylation |
|---|---|---|---|---|---|---|---|
| Ex | Olgmr | group | acrylate | Ratio | Polymn | or Amine | group |
| Ink 1 | D1 | BA | HEA | 2:1 | 15 | NA | AA |
| Ink 2 | D2 | BA | HBA | 2:1 | 15 | NA | AA |
| lnk 3 | A4 | BA | GMA | 2:1 | 15 | NA | AA |
| Ink 4 | A5 | LA | GMA | 2:1 | 15 | NA | AA |
| Ink 5 | A1 | ODA | HBA | 2:1 | 12 | NA | AA |
| lnk 6 | C1 | ODA | HBA | 2:1 | 12 | APP | AA |
| Ink 7 | C2 | ODA | HBA | 2:1 | 12 | DMPA | AA |
| lnk 8 | D3 | ODA | HEA | 2:1 | — | NA | AA |
| Ink 9 | A7 | BA | HEA | 1:1 | 6 | NA | RP |

Footnotes
— is unknown or not measured; NA = Not Applicable; and “RP” denotes the reaction product of Empol 1022, DiTMP, and AA

Rheology Tests

All rheology measurements were performed on a Haake RS150 Cone and Plate rheometer equipped with an aluminum 60mm, 1-degree spindle. The rheometer was thermostated by the use of a Peltier device at 25° C. for all measurements. The test procedure (Total 20 minutes) was as follows. Hold instrument at 25° C. for 300 seconds. Yield point was measured under controlled stress from 0 Pa to 25 Pa at 25° C. for 540 seconds. The viscosity curve was measured at controlled rate from 0.06 seconds⁻¹ to 100 seconds⁻¹ at 25° C. for 360 seconds.

Yield Point

A simple definition for the yield point is the smallest possible stress necessary to induce stationary flow of the sample. That means that the sample behaves like a solid if stresses below the yield point are applied. Structures within the material are not destroyed, the deformation due to the applied stress is reversible, and the shape of the sample regains after setting the applied stress to zero. With stresses larger than the yield point, the structures within the samples are destroyed and the deformation increases dramatically leading to stationary flow of the sample. The transition between the solid and the liquid behaviour can be interpreted as the yield point.

Viscosity Curve

The measurement of the viscosity curve helps to classify a substance according to one of the possible characteristics: Newtonian, Psuedoplastic, and Thixotropic (see graphs below). With the steady state flow curve in the controlled rate mode, a certain shear rate is selected. Once the steady state conditions have stabilised, a data point for the viscosity will be collected. Then the selected shear rate is increased or decreased in order to obtain a constant shear stress value after a certain time. The shear rate data points are collected from 0 to 100 (1 /seconds) to obtain a steady state flow curve. The data reported in the Tables are for shear rates of 50 and 100 (1/seconds).

Results

The data in Table 9 below shows that incorporating hydrophobic groups into radiation curable acrylated oligomers gives improved pigment wetting for use in for example graphic art applications.

TABLE 9
Rheology data for Magenta inks of the invention

| | | | | | Neat Resin |
|---|---|---|---|---|---|
| | | Yield/ | Viscosity | Viscosity | Viscosity |
| Ex | Olgmr | Pa | @ 1/50 s.cP | @ 1/100 s.cP | @ 25° C. |
| Ink 1 | D1 | >25 | 3620 | 2620 | 29500 |
| Ink 2 | D2 | <1 | 3540 | 2620 | 7400 |
| Ink 3 | A4 | 19 | 1160 | 881 | 760 |
| | | | | | (@ 60° C.) |
| Ink 4 | A5 | >25 | 1940 | 1370 | 1000 |
| | | | | | (@ 60° C.) |
| Ink 5 | A1 | 0 | 1380 | 990 | — |
| Ink 8 | D3 | 15 | 1300 | 1000 | — |

Comparing Ink 8 (D3) with Ink 1 (D1) and Ink 5 (A1) with Ink 2 (D2) indicates that substitution of the more hydrophobic group ODA for BA gave inks with lower overall viscosities and lower yield points. Both of these attributes are important to achieving inks with the preferred improved performance.

The data in Table 10 below shows that incorporating of amines or amides into radiation curable acrylated oligomers also gives improved pigment wetting for use in for example graphic art applications.

TABLE 10
Rheology data for Yellow inks of the invention

| | | | Viscosity | Viscosity |
|---|---|---|---|---|
| Ex | Olgmr(s) | Yield(Pa) | (@ 50 s⁻¹⁾ | (@ 100 s⁻¹⁾ |
| Ink 5 | A1 | 19 | 3100 | 2220 |
| Ink 6 | C1 & Eb 140 | 15 | 3013 | 2236 |

The inks were used to printed samples with a Cavanaugh Hand Proffer. It was observed that the ink of Example 6 which also incorporated Ebecryl 140 (from UCB) exhibited improved transparency and strength when compared to the ink of Example 5. This indicates the amine modification improved the pigment wetting of this yellow pigment.

The data in Tables 11 to 14 below show that irrespective of pigment colour the inks of the present invention give improved pigment wetting compared to known inks and thus the oligomers used and described herein may act as universal radiation curable pigment wetters. Comp X and Comp Y are comparative inks prepared using the ink formulation of Table 7 using the known oligomers Ebecryl 450 and Ebecryl 812 both available commercially from UCB Chemicals.

TABLE 11
Rheology data for Yellow inks

| | | | Viscosity | Viscosity |
|---|---|---|---|---|
| Ex | Oligomer | Yield (Pa) | (@ 50 s⁻¹⁾ | (@ 100 s⁻¹⁾ |
| Comp X | EB 450 | 5 | 2,052 | 1,539 |
| Comp Y | EB 812 | 8 | 960 | 787 |
| Ink 9 | A7 | 5 | 2,825 | 2,226 |

TABLE 12
Rheology data for Magenta inks

| | | | Viscosity | Viscosity |
|---|---|---|---|---|
| Ex | Oligomer | Yield (Pa) | (@ 50 s⁻¹⁾ | (@ 100 s⁻¹⁾ |
| Comp X | EB 450 | <1 | 1,596 | 1,258 |
| Comp Y | EB 812 | 20 | 1,512 | 1,163 |
| Ink 9 | A7 | 0 | 2,796 | 2.681 |

TABLE 13
Rheology data for Cyan inks

| | | Yield | Viscosity | Viscosity |
|---|---|---|---|---|
| Ex | Oligomer | (Pa) | (@ 50 s⁻¹) | (@ 100 s⁻¹) |
| Comp X | EB 450 | 17 | 1,256 | 920 |
| Comp Y | EB 812 | 11 | 1,008 | 821 |
| Ink 9 | A7 | 10 | 1,480 | 1,210 |

TABLE 14
Rheology data for Black inks

| | | Yield | Viscosity | Viscosity |
|---|---|---|---|---|
| Ex | Oligomer | (Pa) | (@ 50 s⁻¹) | (@ 100 s⁻¹) |
| Comp X | EB 450 | >25 | 1,616 | 1,023 |
| Comp Y | EB 812 | 21 | 1,325 | 937 |
| Ink 9 | A7 | 15 | 1,540 | 1,290 |

Thus an ink of the invention (Ink 9) compares favorably with known inks prepared from two commercially available resins. In the case of Comp X, yield points for black and cyan are very high and will result in an ink that prints poorly on press. Comp Y has large yield points for black and magenta inks compared to Ink 9 which demonstrates consistently low yield points for all colors.

What is claimed is:

1. A radiation-curable formulation substantially-free of volatile organic compounds (VOCs), the formulation comprising
(a) from about 5% to about 70% by weight of a monomer diluent comprising at least one activated unsaturated moiety;
(b) optionally up to about 10% by weight a photo-initiator; and
(c) from about 30% to about 95% by weight of at least one polymer and/or oligomer obtained and/or obtainable from a monomer comprising at least one activated unsaturated moiety,
where the formulation and/or components thereof exhibit at least one of the following properties:
(w) the polymer component (c) has a solubility parameter (SP) of more than about 15 J^{1/2} cm^{-3/2};
(x) the polymeric component (c) has a number average molecular weight (Mₙ) of less than about 15,000 daltons;
(y) the formulation has a viscosity-of up to about 10,000 centipoise and no more than 50% of diluent; and/or
(z) the polymeric component (c) having a dispersing power (⊖) as defined herein of up to about 1.0.

2. The formulation as claimed in claim 1, in which component (a) and component (c) are the same.

3. The formulation as claimed in claim 1 in which component (a) and component (c) comprise at least one:
semi-telechelic nitrogen-functional oligomers of formula
R₁R₂N—(CH₂)ₘ—(NH)ₙ-A
in which
A is a macromonomer moiety bearing at least one pendant ethylenic unsaturation with a degree of polymerization from about 2 to about 50;
n is 0 or 1;
m is from 0 to 18
R₁ and R₂ are both independently selected from H, and optionally substituted C₁₋₁₈hydrocarbo.

4. The formulation as claimed in claim 1 in which component (a) and component (c) comprise at least one:
low molecular weight vinylic polymers of at least one monoalkenyl aromatic monomer and at least one acrylic monomer having a dispersion index less than about 2 and a number average molecular weight from about 1000 to 6000 obtained and/or obtainable by a bulk polymerization process which comprises the steps of continuously:
(a) charging a mixture of vinylic monomers into a continuous stirred reactor zone containing a molten resin mixture of unreacted vinylic monomers and said vinylic polymer product;
(b) maintaining the molten resin mixture at a reaction temperature from about 235° C. to 310° C.; and
(c) maintaining a flow rate through said reaction zone sufficient (1) to provide a residence time of said charged vinylic monomer mixture in said reaction zone of at least about 2 minutes to provide a reaction product; and (2) to maintain a predetermined level of reaction mixture in said reaction zone.

5. The formulation as claimed in claim 1 in which component (a) and component (c) comprise at least one:
low molecular weight vinylic polymer having a narrow molecular weight distribution and optionally a low chromophore content, the polymer obtained and/or obtainable by a bulk polymerization process comprising the steps of continuously:
(a) charging into a continuous mixed reactor zone containing a molten resin mixture;
(i) a mixture of vinyl monomers comprising at least one monoalkenyl aromatic monomer and at least one acrylic monomer;
(ii) a polymerization initiator in amounts to provide a molar ratio of said initiator to said mixture of vinyl monomers from about 0.0005:1 to 0.04:1;
(iii) from about 0 to 25 percent based on the weight of vinyl monomers of a reaction solvent, wherein said molten resin mixture comprises unreacted vinylic monomers and the vinylic polymer product;
(b) maintaining a flow rate through said reaction zone sufficient to:
(i) provide a residence time of said charged vinylic monomer mixture in said reaction zone of from about two minutes to one hour; and
(ii) maintain a predetermined level of reaction mixture in said reaction zone, and;
(c) maintaining the molten resin mixture at a reaction temperature within the range from about 180° C. to 270° C. sufficient to provide accelerated conversion to a readily processable, uniform, concentrated polymer product having a number average molecular weight of 500 to 6000, a polydispersity of less than about 2.5 and a distribution index of less than about 4.5

6. The formulation as claimed in claim 1 in which component (a) and component (c) comprise at least one:
high solids, non-styrenic acrylic polymers having a number average molecular weight of about 1000 to 2500 a polydispersity of less than about 3; a dispersion index of up to about 5 and optionally a low chromophore content, the polymer obtained and/or obtainable by a continuous bulk polymerization process comprising the steps of continuously:
(a) charging into a continuous mixed reactor zone containing a molten resin mixture consisting essentially of;
(i) at least one acrylic monomer;
(ii) a polymerization initiator in amounts to provide a molar ratio of said initiator to said acrylic monomer from about 0.0005:1 to 0.06:1,
(iii) from about 0 to 25 percent based on the weight of acrylic monomers of a reaction solvent, wherein said molten resin mixture comprises unreacted acrylic monomers and the acrylic polymer product;
(b) maintaining a flow rate through said reaction zone sufficient to:
(i) provide a residence time of said charged acrylic monomer in said reaction zone of from about 1-30 minutes; and
(ii) maintain a predetermined level of reaction mixture in said reaction zone, and;
(c) maintaining the molten resin mixture at a reaction temperature within the range of from about 180° C. to 270° C. sufficient to provide a uniform, concentrated polymer product optionally at an accelerated conversion and optionally such that the product is readily processable, wherein the product has a number average molecular weight of 500 to 6000, a polydispersity of less than about 2.5 and a distribution index of less than about 4.5

7. The formulation as claimed in claim 1 in which component (a) and component (c) comprise at least one:
low molecular weight hydroxy-functional acrylate resins optionally water reducible and/or water dispersible, the resin comprising recurring units of:
(a) an allylic alcohol optionally in amount of about 5 to about 50% by weight, the alcohol having the general structure:
CH₂═CR—CH₂(A)ₙOH
in which
n is less than about 3.0;
A is a (C₁₋₁₂hydrocarbylene)oxy group; and
R is selected from the group consisting of: hydrogen and C₁₋₁₂hydrocarbyl;
(b) a C₁₋₂₀hydrocarbyl; vinyl aromatic; aryl acrylate and/or methacrylate monomer; optionally in amount of about 50% to about 90% by weight;
(c) optionally, one or more ethylenically unsaturated monomers (optionally in an amount from about 1 to about 50% by weight), the monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, (meth)acrylic acids; (meth)acrylates, (meth)acrylamides and conjugated dienes;
where the acrylate resin has:
a hydroxyl number from about 15 to about 500 mg KOH/g;
an acid number within the range of about 5 to about 330 mg KOH/g;
a number average molecular weight Mn from about 500 to about 10,000 daltons; and/or
a T_{g} from about −20° C. to about 50° C. as measured by differential scanning s calorimetry (DSC).

8. The formulation as claimed in claim 1 in which component (a) and component (c) comprise at least one:
low-molecular-weight, hydroxy-functional acrylate resins which comprise recurring units of:
(a) a propoxylated allylic alcohol of the formula
CH₂═CR—CH₂(A)ₙOH
in which
A is an oxypropylene group,
R is selected from the group consisting of hydrogen and C₁₋₅alkyl, and
n, which is the average number of oxypropylene groups in the propoxylated allylic alcohol, has a value less than or equal to 2;
(b) C₁₋₂₀alkyl or aryl acrylate or methacrylate monomer, and
(c) optionally, one or more ethylenic monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, (meth)acrylic acids, (meth)acrylamides and conjugated dienes;
where the acrylate resin has a hydroxyl number within the range of about 50 to about 450 mg KOH/g, and a number average molecular weight within the range of about 500 to about 10,000.

9. The formulation as claimed in claim 1 in which component (a) and component (c) comprise at least one:
low molecular weight, hydroxy functional acrylate resins which comprise recurring units of:
(a) an allylic alcohol having the general structure
CH₂═CR—CH₂OH
in which R is selected from the group consisting of hydrogen and C₁₋₅alkyl, and
(b) a C₁₋₂₀alkyl or aryl acrylate or methacrylate monomer; and
(c) optionally, one or more ethylenic monomers selected from the group consisting of vinyl aromatic monomers, unsaturated nitrites, vinyl esters, vinyl ethers, vinyl halides, vinylidene halides, unsaturated anhydrides, unsaturated dicarboxylic acids, acrylic and methacrylic acids, acrylamide and methacrylamide, and conjugated dienes;
wherein the acrylate resin has a hydroxyl number within the range of about 20 to about 500 mg KOH/g, and a number average molecular weight within the range of about 500 to about 10,000.

10. The formulation as claimed in claim 1 in which component (a) and component (c) comprise at least one:
acrylic resins which comprise recurring units of:
(1) an allylic alcohol or a propoxylated allyl alcohol of the formula
CH₂═CR—CH₂(A)ₙOH
in which
A is an oxypropylene group,
R is selected from the group consisting of hydrogen and C₁₋₅alkyl, and
n, which is the average number of oxypropylene groups in the propoxylated allylic alcohol has a value within the range of about 1 to about 2;
(2) a vinyl aromatic monomer; and
(3) one or more C_{1 20}alkyl or aryl acrylate or methacrylate monomers; where the resin has a glass-transition temperature within the range of about −20° C. to about 50° C., a hydroxyl number within the range of about 60 to about 160 mg KOH/g, and a number average molecular weight within the range of about 1000 to about 5000

11. The formulation as claimed in claim 1 in which component (a) and component (c) comprise at least one:
water reducible and/or water dispersible resins which comprise recurring units of:
(1) from about 5 to about 50% by weight of an allylic alcohol or a propoxylated allyl alcohol of the formula
CH₂═CR—CH₂(A)ₙOH
in which
A is an oxypropylene group,
R is selected from the group consisting of hydrogen and C₁₋₅alkyl, and
n, which is the average number of oxypropylene groups in the propoxylated allylic alcohol has a value within the range of about 1 to about 2;
(2) from about 50 to about 90% by weight of a vinyl aromatic monomer; and
(3) from about 1 to about 50% by weight of an acrylic acid monomer;
where the resin has a number average molecular weight within the range of about 500 to about 10,000, a hydroxyl number within the range of about 15 to about 250 mg KOH/g, and an acid number within the range of about 5 to about 330 mg KOH/g.

12. The formulation as claimed in claim 1, where component (c) has a SP of from about 15 J^{1/2} cm^{-3/2} to about 30 J^{1/2} cm^{-3/2}.

13. The formulation as claimed in claim 12, where component (c) has a SP from about 18 J^{1/2} cm^{-3/2} to about 25 J^{1/2} cm^{-3/2}.

14. The formulation as claimed in claim 1, where component (c) has a number average molecular weight (Mₙ) from about 200 to about 20,000 daltons.

15. The formulation as claimed in claim 14, where component (c) has a number average molecular weight (Mₙ) from about 500 to about 15,000 daltons.

16. The formulation as claimed in claim 1, where component (c) has a number average molecular weight (Mₙ) from about 1,000 to about 10,000 daltons.

17. The formulation as claimed in claim 1, with a viscosity of up to about 2,000 centipoise per g of polymeric component (c) at a temperature of 25° C.

18. The formulation as claimed in claim 1, where the polymeric component (c) has a dispersing power (⊖) from about 1×10⁻⁵ to about 0.8 DP(equivalents)/(mol×daltons).

19. The formulation as claimed in claim 18, where the polymeric component (c) has a ⊖ from about 1×10⁻³ to about 0.5 DP(equivalents)/(mol×daltons).

20. The formulation as claimed in claim 19, where the polymeric component (c) has a ⊖ from about 0.01 to about 0.1 DP(equivalents)/(mol×daltons).

21. The formulation as claimed in claim 1 claim which further comprises a pigment.

22. The formulation as claimed in claim 21, which is an ink effective for use in flexography, and/or lithography.

23. A flexographic or lithographic method which employs the formulation as claimed in claim 1.

24. An article printed by a formulation as claimed in claim 1.

25. A process for printing an article comprising the steps of:
(a) applying thereto a formulation as claimed in claim 1;
(b) irradiating said article sufficiently to cause polymerization of the formulation thereon.
